(19) United States
(12) Patent Application Publication
(10) Pub. No.: US 2004/0051279 A1
(43) Pub. Date: Mar. 18, 2004

(54) Mobile elevating chair apparatus

(76) Inventors: William M. Grant, Zanesville, OH (US); Paul Caronna, Lacombe, LA (US)

Correspondence Address: GARVEY SMITH NEHRBASS & DOODY, LLC, THREE LAKEWAY CENTER, 3838 NORTH CAUSEWAY BLVD., SUITE 3290, METAIRIE, LA, 70002

(21) Appl. No.: 10/244,875

(22) Filed: Sep. 17, 2002

(51) Int. Cl. B62B 1/00

(52) U.S. Cl. 280/638

(57) ABSTRACT

A mobile elevation chair apparatus includes trapezoidal shaped base that has a periphery defined by front and rear edges and side edges. The base has a lower surface fitted with at least to steerable casters as wheels and an upper surface. The base is wider at the rear edge compared to the front edge so the side edges form an acute angle. A telescoping piston is mounted to the upper surface of the base. A lever enables the piston to be elongated or shortened, the lever extending rearwardly from the piston. A chair is mounted to the top if the piston, the chair having a seat base and a seat back, the seat back portion being mounted to the piston. A plurality of wheels are mounted to the base including the front steerable casters that are mounted to the lower surface of the base at least partially at a position inside the periphery of the base and a pair of rear wheels mounted to the base at a position outside the periphery of the base. A brake mechanism is provided for braking at least one of the wheels.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to elevating chairs and more particularly to a mobile elevating chair apparatus that has particular utility in the care of individuals that have particular medical needs, including the need for assisted mobility and support.

2. General Background of the Invention

There are a number of wheeled devices that are available to persons having particular medical needs, disabilities, injuries caused by trauma and the like. These chairs are available in many different forms. One of the most common forms is the well known wheelchair that can be either manually operable or motorized.

Wheelchairs are very bulky devices that are hard to maneuver. They do not enable an individual to approach a table in virtually every restaurant or hotel situation for example.

Many individuals have a desire to sit at a dinner table or to visit their favorite restaurant when dining out notwithstanding their particular medical condition.

Several wheeled devices have been patented that attempt to solve the problems of providing transportation for individuals while providing improvements over the common wheelchair.

As an example, the Pratt U.S. Pat. No. 2,609,862 discloses a hospital chair that has a triangular base with a single front wheel and two rear wheels, all of the wheels being positioned on the underside of the base. The Pratt chair includes a telescoping piston for elevating a chair that includes a seat back, seat base, and leg supports. The Pratt chair also includes armrests. A lever extends behind the piston for elevating and lowering the seat relative to the base.

The Guyton U.S. Pat. No. 4,184,524 discloses a seat that is adjustable in height that includes a footrest and a base that has four radially extending members, each with its own foot.

The Congleton U.S. Pat. No. 4,552,404 discloses a neutral body position chair that includes a base having wheels and a pedestal that telescopes to elevate and lower the chair. The chair includes seat base and seat back portions.

A patient transfer device is shown in U.S. Pat. No. 5,438,722. The device includes a cushioned chair with wheels that facilities patient transfer in and out of a hospital clinical bed. The patient transfer device provides an entirely different method of transferring patients that avoids lifting the total body weight of the patient and that provides the maximum comfort for the patient.

An ambulatory care chair is the subject of U.S. Pat. No. 6,089,593.

The Harroun U.S. Pat. No. 6,220,620 discloses a wheeled height adjustable rehabilitation chair. The device includes a base having wheels that are steerable and a chair that sits upon the base with a pedestal. The wheels are located outboard of the seat to enhance stability, while the legs are positioned to provide a free space for the user's legs to facilitate user propulsion of the chair when the user is either sitting or standing. The seat chair is of narrow depth, allowing freedom of leg motion when the user is seated.

Another elevating chair is shown in U.S. Pat. No. 6,296,310 that employs an actuator which is integral with a hydraulic cylinder that causes a piston to raise and lower.

The Pratt U.S. Pat. No. 6,322,250 discloses an x-ray chair for providing support and comfort to a patient seated therein during an x-ray procedure.

A design Pat. Des. 354,176 issued to Schwaegerle discloses a medical lift chair that appears to show a base, a hydraulic cylinder having a lever for operating the chair, probably to elevate it, and a chair that has armrests, a headrest and a footrest portion. The applicant is only aware of this design patent. However, it is noted that the patent is owed by Reliance Medical Products, Inc. of Mason, Ohio.

### BRIEF SUMMARY OF THE INVENTION

The present invention provides an improved wheeled elevating chair apparatus. The device has a trapezoidal shaped base that includes an upper surface, a lower surface, and a periphery defined by a front edge, a rear edge, and a pair of side edges. The side edges form an acute angle. The rear edge defines the widest part of the base.

A pair of rear wheels are mounted to the base at the rear edge.

A pair of steerable front wheels are mounted to the base at the front edge, at least part of the steerable front wheels being mounted within the periphery of the base.

Brakes are mounted on the pedestal and movable between released and locking positions, the rear wheels being locked to prevent rolling when the brakes are in the locking position.

A pedestal is mounted on the base and extends vertically above the base upper surface, the pedestal including a plurality of pedestal members that telescope, at least one of said pedestal members being a first pedestal member attached to the base and a second pedestal member that is attached to the first pedestal member and elevates relevant to the base.

A hydraulic jacking mechanism elevates the second pedestal member relative to the first pedestal member. The jacking mechanism includes a lever arm that extends from the pedestal rearwardly to a position that is above and behind the base.

A chair is mounted on the pedestal, the chair including a seat base and seat back. The chair is able to change elevation relative to the base by moving the second pedestal member when the second pedestal member is elevated or lowered using the jacking mechanism.

The lower arm elevates the chair when depressed and moved from a higher to a lower position and the chair and second pedestal member lower the chair when the lever arm is depressed to a lowest position and maintained in that lowest position.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements and wherein:

FIG. 1 is the perspective of the preferred embodiment of the apparatus of the present invention;

FIG. 2 is a partial perspective of the preferred embodiment of the apparatus of the present invention;

FIG. 3 is an elevation view of the preferred embodiment of the apparatus of the present invention;

FIG. 5 is a partial perspective of the preferred embodiment of the apparatus of the present invention;

FIG. 5A is a fragmentary perspective of the preferred embodiment of the apparatus of the present invention illustrating the folding handlebar; and

FIG. 6 is a partial perspective of the preferred embodiment of the apparatus of the present invention illustrating the footrest portion thereof.

### DETAILED DESCRIPTION OF THE INVENTION

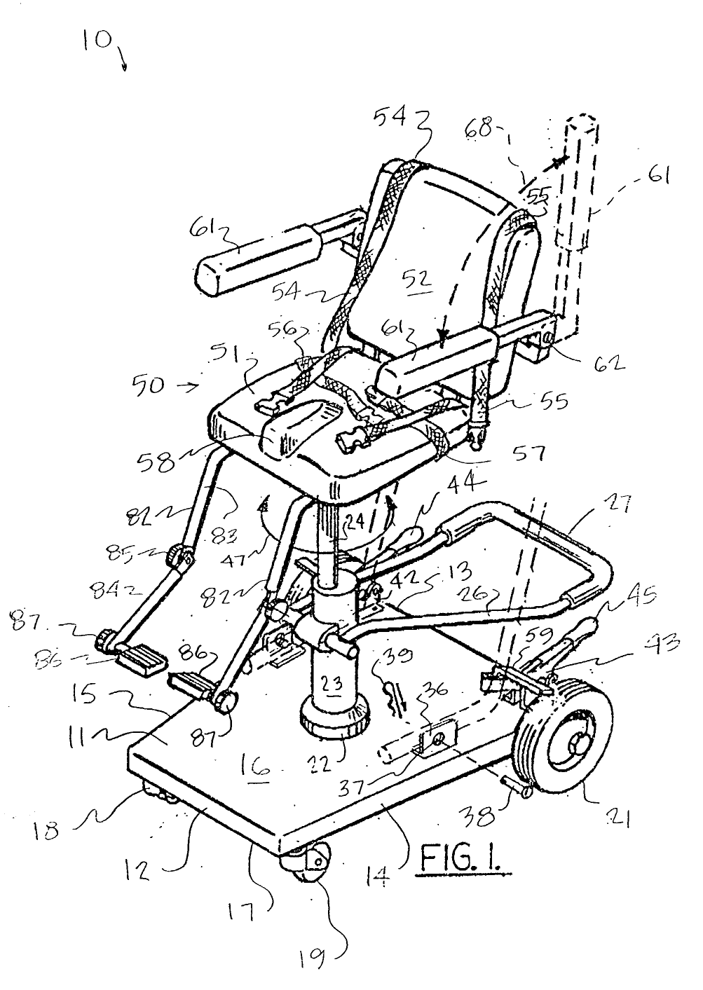

FIGS. 1-3 show the preferred embodiment of the apparatus of the present invention designated by in drawing the numeral 10. Mobile chair apparatus 10 includes a trapezoid shaped base 11 that has a front edge 12, rear edge 13, and a pair of opposed side edges 14-15, that together define a periphery.

The left side 14 and right side 15 form an acute angle as shown in FIG. 4 so that the dimension A of rear edge 13 is a longer dimension than the dimension B designated by the numeral 41 of the front edge 12. In addition, a special wheel placement for a plurality of preferably four wheels that are attached to the underside 17 of the base 11 enable the apparatus 10 of the present invention to be very easily maneuvered into tight places such as between the legs of a small table. Thus the present invention enables a person with special medical needs to be able to maneuver to a position next to a standard table (e.g. restaurant table) or a table with narrow dimensions.

The apparatus 10 of the present invention thus provides a pair of front wheels 18, 19 under base 11 and within its periphery at least in part. Casters 18, 19 are swivel wheels such as swiveling casters. These casters 18, 19 swivel 360 degrees about a vertical axis and enable the apparatus 10 to be easily steered.

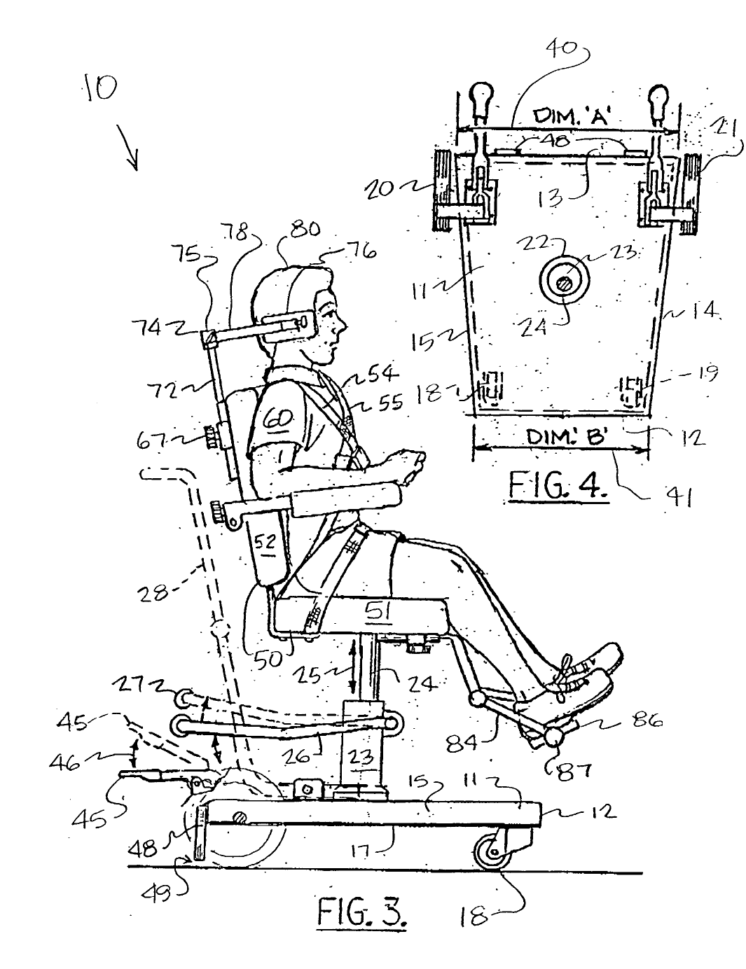

The plurality of wheels that support base 11 include two rear wheels 20, 21. The rear wheels 20, 21 are positioned at the rear edge 13 of base 11 and outboard are laterally spaced away from the sides 14, 15 as shown in FIG. 4. Conversely, the steering casters 18, 19 that define the front wheels are positioned under base 11, being attached to underside 17 as shown in FIGS. 1-4. Therefore, steering casters 18,19 do not interfere with placement of base 11 between the legs of a table. A pair of spaced apart struts 48 are attached to base 11 at rear edge 13 as shown in FIGS. 3 and 4. Rear struts 48 prevent tipping over if an occupant of chair 50 happens to push against an object in front of the chair 50 (e.g. table, wall, etc.) when the brakes 42, 43 are locked.

The upper surface 16 of pedestal 11 supports pedestal 22. Pedestal 22 can be a hydraulic cylinder arrangement that includes hydraulic cylinder 23 and elevating push rod 24 that elevates and lowers as illustrated by the arrow 25 in FIG. 3.

Actuator arm 26 provides a footrest or foot pedal 27 that enables a user to stand behind the chair apparatus 10 and either raise or lower the chair 50 part of the apparatus 10 and at the same time elevate a user 60 that occupies the seat 51 part of chair 50. Pedestal 22, its hydraulic cylinder 23 and push rod 24 arrangement as well as actuator 26 are all commercially available and have in the past been provided for elevating a seat such as on common barber chairs and those chairs used in beauty salons.

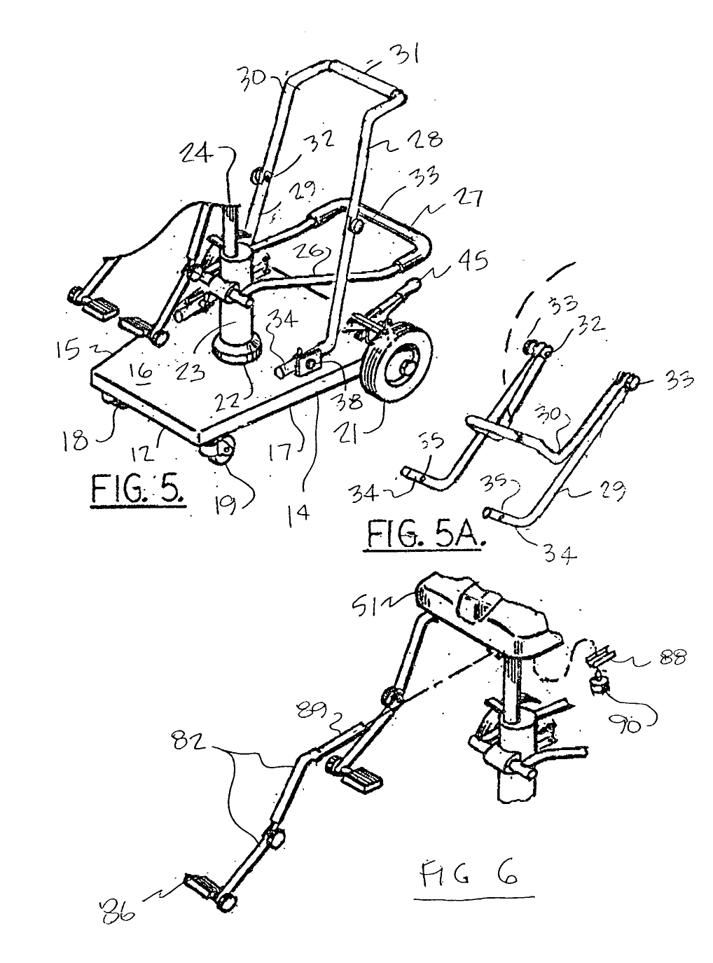

The apparatus 10 of the present invention provides a handlebar 28 that enables a friend or family member to maneuver the apparatus 10 while a user 60 occupies the chair 50. Handlebar 28 can be a two part apparatus and includes a lower inclined section 29 that is pivotally attached to an upper incline section 30. The upper incline section 30 has a gripping surface 31 that can be for example covered in foam or other material that helps a friend or family member maneuver the apparatus 10. Pivotal connections 32 connect the upper incline section 30 to the lower include section 29. An adjustment knob 33 can be used to tighten the pivotal connection 32 when in the operating position of FIGS. 3 and 5.

Lower horizontal section 29 provides two spaced apart horizontal sections 34, each having an opening that enabled the handlebar 28 to be attached in a removable fashion to base 11. A pair of spaced apart support brackets 36 are provided for forming a connection with handlebar 28. Each support bracket can have generally L-shaped cross section as shown in FIG. 1, providing an opening 37 that is receptive of locking pin 38. The locking pin 38 passes through opening 37 of support bracket 36 and opening 35 of horizontal section 34 in order to lock the handlebar 28 to the base 11. A retainer clip 39 can be provided for insuring that the locking pin 38 does not become inadvertently dislodged.

In FIG. 4, the dimension line 40 designates dimension A which is the width of rear edge 13 of base 11.

The dimension line 41 in FIG. 4 designates the width as dimension B of front edge 12 of base 11. The length of base 11 between edge 12 and edge 13 can be a distance that is greater than the rear width 40.

A pair of brakes 42, 43 are provided, one for each rear wheel 20, 21. Each brake is preferably a cam operated brake that provides a brake lever for a full 45 respectively. Brakes 42, 43 can employ a push down lever clamp mechanism that can be purchased from Rockler Woodworking and Hardware (e.g. item number 20731 in the Rockler catalog dated Summer, 2002. Such a mechanism is fitted with a transverse bar 59 that grips the wheel 20 or 21 to be locked in a braked, non-rolling position. In this fashion, a user simply depresses the brake lever 44 or 45 as illustrated by arrow 46 in FIG. 3. Bar 59 then locks wheel 20 or 21. In the lower position shown in FIG. 3, the brake is locked so that the rear wheels 20, 21 cannot rotate relative to base 11.

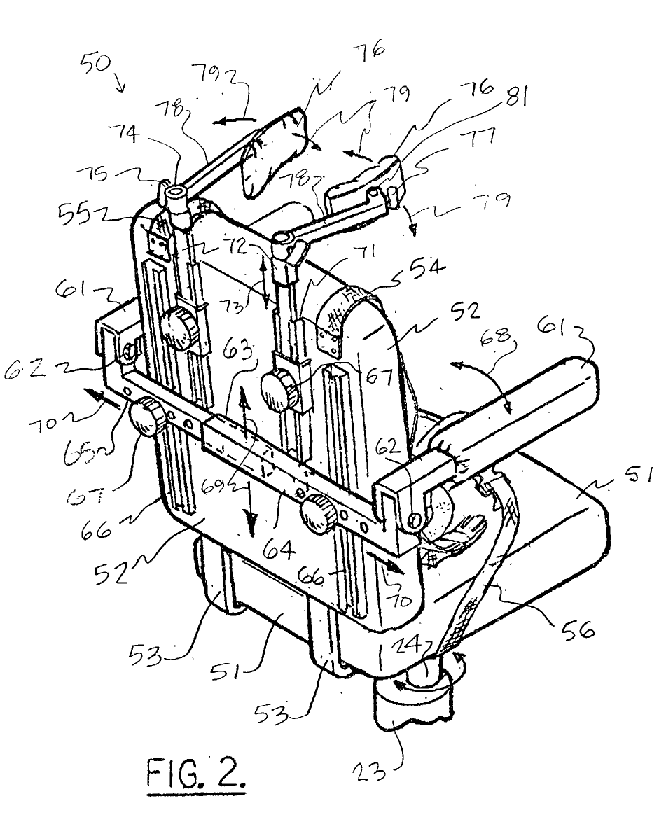

Seat 50 in FIGS. 1-3 includes a seat bottom 51 and a seat back 52. The seat bottom 51 and seat back 52 are connected with a plurality of brackets 53 as shown in FIG. 2. A plurality of belts are provided for holding an occupant or user 60 to the chair seat 51 and chair back 52 as shown in FIG. 3. These belts include a pair of shoulder belts 54, 55 that are preferably diagonally positioned across the chest and torso of an occupant 60 as shown in FIG. 3 during use. Each belt 54 can be a two part belt connected with a buckle. A seatbelt is also provided that attaches to the seat bottom 51. The seatbelt includes seatbelt sections 56, 57 that can be connected using a commercially available buckle.

Leg spacer at 58 is provided on the upper surface of seat 51 for separating the legs of an occupant 60 at the occupant's knee area as show in FIGS. 1 and 3 for providing greater stability to user 60 that do not have perfect use of his or her legs.

A pair of armrests 61 are provided, each pivotally connected at pivotal connection 62 to telescoping support 63 that extends across the back of seat back 52 (see FIG. 2). Telescoping support 63 enables the distance between armrests 61 to be varied to fit a particular occupant 60. A telescoping support 63 can be comprised of two telescoping sections 64, 65 that can be affixed at a selected telescoping position using adjustment nuts 67. The adjustment nuts 67 are preferably in the form of two spaced apart, left and right adjustment nuts 67, each having a bolt head that travels in vertical rail 66. As indicated by arrow 69 in FIG. 2, the telescoping support 63 and the connected arms 61 can thus be elevated or lowered to fit a particular occupant 60. The arrow 68 in FIG. 2 illustrates pivotal movement of the arms 61. The arrow 70 in FIG. 2 illustrates telescoping lateral expanding movement of the telescoping support 63.

A pair of vertical rails 61 are provided on the rear surface of seat back 52 as shown in FIG. 2. The rails 71 can be positioned in between rails 66 that support telescoping support 63. Each rail 71 receives a vertical slide 72 having a bushing 74 at its upper end portion. Bushing 74 forms a pivotal connection with arm 78. Each arm 78 supports a curved pad 76 that is shaped generally to conform to the head or neck area of an occupant 60 as shown in FIG. 3.

Each arm 78 can pivot inwardly and outwardly relative to an occupant 60 as indicated by arrows 79. In order to affix the position of each arm 78 and its pad 76 relative to an occupant's head 80, wing nuts 75, 77 are provided. A pivotal connection 81 can provided between the free end of arm 78 and curved pad 76.

A pair of leg supports 82 extend from the underside of seat bottom 51 as shown in FIGS. 1 and 3. Each leg support 82 includes an upper section 83, lower section 84 and pivotal connection 85. At the lower end portion of lower section 84 is provided a footrest 86. The position of the footrest can be adjusted 360 degrees and locked in position using knob 87.

Horizontally positioned rails 88 can be affixed to the underside of seat bottom 51 for forming a connection with the horizontal slide 89 portion of each leg support 82 and locked in position using a threaded know 90 as shown in FIG. 6.

The following is a list of suitable parts and materials for the various elements of the preferred embodiment of the present invention.

PARTS LIST

| DESCRIPTION | PART NUMBER |
|---|---|
| mobile elevating chair apparatus | 10 |
| base | 11 |
| front edge | 12 |
| rear edge | 13 |
| left side | 14 |
| right side | 15 |
| upper surface | 16 |
| lower surface | 17 |
| front wheel | 18 |
| front wheel | 19 |
| rear wheel | 20 |
| rear wheel | 21 |
| pedestal | 22 |
| hydraulic cylinder | 23 |
| pushrod | 24 |
| arrow | 25 |
| actual | 26 |
| foot rest | 27 |
| handlebar | 28 |
| lower inclined section | 29 |
| upper inclined section | 30 |
| gripping surface | 31 |
| pivotal connection | 32 |
| adjustment knob | 33 |
| horizontal section | 34 |
| opening | 35 |
| support bracket | 36 |
| opening | 37 |
| locking pin | 38 |
| retainer clip | 39 |
| dimension line | 40 |
| dimension line | 41 |
| brake | 42 |
| brake | 43 |
| brake lever | 44 |
| brake lever | 45 |
| arrow | 46 |
| arrow | 47 |
| rear strut | 48 |
| gap | 49 |
| seat | 50 |
| seat bottom | 51 |
| seat back | 52 |
| bracket | 53 |
| shoulder belt | 54 |
| shoulder belt | 55 |
| seat belt section | 56 |
| seat belt section | 57 |
| leg spacer | 58 |
| transverse bar | 59 |
| user | 60 |
| arm rest | 61 |
| pivotal connection | 62 |
| telescoping support | 63 |
| section | 64 |
| section | 65 |
| vertical rail | 66 |
| adjustment nut | 67 |
| arrow | 68 |
| arrow | 69 |
| arrow | 70 |
| rail | 71 |
| vertical slide | 72 |
| arrow | 73 |
| bushing | 74 |
| wing nut | 75 |
| curved pad | 76 |
| wing nut | 77 |
| arm | 78 |
| arrow | 79 |
| head | 80 |
| bushing | 81 |
| leg support | 82 |
| upper section | 83 |
| lower section | 84 |
| pivotal connection | 85 |
| foot rest | 86 |
| knob | 87 |
| | 88 |

The foregoing embodiments are presented by way of example only; the scope of the present invention is to be limited only by the following claims.

1. A mobile elevation chair apparatus comprising:
a) a base that has a periphery defined by front and rear edges and side edges, said base having a lower surface, and an upper surface, the base being wider at the rear edge compared to the front edge so that the side edges form an acute angle;
b) an telescoping piston mounted on the upper surface of the base;
c) a lever that enables the piston to be elongated or shortened, the lever extending rearwardly from the piston;
d) a chair mounted upon the top of the piston, the chair having seat base and seat back portions, the seat back portion mounted to the piston;
e) a plurality of wheels mounted to the base, including a pair of front, steerable wheels that are mounted to the lower surface of the base at a position inside the periphery of the base and a pair of rear wheels mounted to the base at a position outside of the periphery of the base; and
f) a brake mechanism for braking at least one of the rear wheels.

2. The mobile elevation chair apparatus of claim 1 wherein the chair has a pair of arm rests that are adjustable in a vertical direction relative to the seat back.

3. The mobile elevation chair apparatus of claim 1 wherein the chair has a pair of leg supports that each have a foot rest, the foot rest extending forwardly of the seat base.

4. The mobile elevation chair apparatus of claim 1 further comprising head supports that are attached to the seat back portion and that extend to left and right sides of an occupant's head when the occupant is sitting upon the seat base.

5. The mobile elevation chair apparatus of claim 1 further comprising a plurality of belts for securing an occupant to the chair including at least seat belts.

6. The mobile elevation chair apparatus of claim 1 further comprising a plurality of belts for securing an occupant to the chair including at least shoulder belts.

7. The mobile elevation chair apparatus of claim 1 further comprising a handlebar attached to the base and extending behind the seat for enabling an attendant to push and steer the base.

8. The mobile elevation chair apparatus of claim 2 further comprising a joint for at least one of the arm rests that enables the arm rest to pivot.

9. The mobile elevation chair apparatus of claim 1 further comprising a spacer mounted to the seat base for maintaining a user's legs in space apart positions.

10. A wheeled elevating chair apparatus, comprising:
a) a trapezoidal base having an upper surface, a lower surface, a front edge, a rear edge and a pair of side edges that form an acute angle, wherein the rear edge defines the widest part of the base;
b) a pair of rear wheels mounted to the base at the rear edge;
c) a pair of steerable front wheels mounted to the base at the front edge;
d) brakes mounted on the pedestal and movable between released and locking positions, the rear wheels being locked to prevent rolling when in the locking position;
e) a pedestal mounted on the base and extending vertically above the base upper surface, the pedestal including a plurality of pedestal members that telescope, at least one of said pedestal members being a first pedestal member attached to the base and a second pedestal member that is attached to the first pedestal member and elevates relative to the base;
f) a hydraulic jacking mechanism that elevates the second pedestal member relative to the first pedestal member, said jacking mechanism including a lever arm that extends from the pedestal rearwardly to a position that is above and behind the base;
g) a chair mounted to the pedestal, the chair having a seat and seat back the chair changing elevation relative to the base by moving with the second pedestal member when the second pedestal member is elevated or lowered using the jacking mechanism; and
h) wherein the lower arm elevates the chair when it is depressed and moved from a higher to a lower position; and
i) wherein the chair and second pedestal member lower the chair when the lever arm is depressed to a lowest position and maintained in that lowest position.

11. The mobile elevation chair apparatus of claim 10 wherein the chair has a pair of arm rests that are adjustable in a vertical direction relative to the seat back.

12. The mobile elevation chair apparatus of claim 10 wherein the chair has a pair of leg supports that each have a foot rest, the foot rest extending forwardly of the seat base.

13. The mobile elevation chair apparatus of claim 10 further comprising head supports that are attached to the seat back portion and that extend to left and right sides of an occupant's head when the occupant is sitting upon the seat base.

14. The mobile elevation chair apparatus of claim 10 further comprising a plurality of belts for securing an occupant to the chair including at least seat belts.

15. The mobile elevation chair apparatus of claim 10 further comprising a plurality of belts for securing an occupant to the chair including at least shoulder belts.

16. The mobile elevation chair apparatus of claim 10 further comprising a handlebar attached to the base and extending behind the seat for enabling an attendant to push and steer the base.

17. The mobile elevation chair apparatus of claim 11 further comprising a joint for at least one of the arm rests that enables the arm rest to pivot.

18. The mobile elevation chair apparatus of claim 10 further comprising a spacer mounted to the seat base for maintaining a user's legs in space apart positions.
